(19) United States
(12) Patent Application Publication
(10) Pub. No.: US 2023/0203217 A1
(43) Pub. Date: Jun. 29, 2023

(54) TWO-COMPONENT COMPOSITION, AND USES THEREOF

(71) Applicants: BOSTIK SA, Colombes (FR); CENTRE NATIONAL DE LA RECHERCHE SCIENTIFIQUE, Paris (FR); UNIVERSITE DE BORDEAUX, BORDEAUX (FR); INSTITUT POLYTECHNIQUE DE BORDEAUX, TALENCE (FR)

(72) Inventors: Marine DELGADO, VENETTE (FR); Guillaume MICHAUD, VENETTE (FR); Boris COLIN, VENETTE (FR); Frédéric SIMON, VENETTE (FR); Stéphane FOUQUAY, COLOMBES (FR); Mathieu PUCHEAULT, TALENCE CEDEX (FR)

(21) Appl. No.: 17/996,132

(22) PCT Filed: Apr. 7, 2021
(86) PCT No.: PCT/FR2021/050611

§ 371 Date: Oct. 13, 2022

(30) Foreign Application Priority Data
Apr. 16, 2020 (FR) FR2003810

(51) Int. Cl. C08F 210/14; C08F 220/14; C08K 5/55; C08F 2/44; C08F 2/56

(52) U.S. Cl. CPC C08F 210/14; C08F 220/14; C08K 5/55; C08F 2/44; C08F 2/56; C08F 2810/20

(57) ABSTRACT

The present invention relates to a two-component composition comprising a first part (A) comprising a borane BH₃-amine complex and an alkene compound, and a second part (B) comprising at least one radically polymerizable compound comprising at least one ethylenic bond, and to an adhesive composition obtained therefrom, and also to uses thereof. The invention also relates to articles made with this composition.

### FIELD OF THE INVENTION

The present invention relates to a two-component composition, an adhesive composition obtained therefrom, and also the uses thereof. The invention also relates to articles made with this composition.

### TECHNICAL BACKGROUND

The nature of the surface of a substrate can be characterized by its surface energy. Low surface energy substrates, such as polyolefins (polyethylene, polypropylene, polybutene, polyisoprene, polybutadiene, polyfarnesene, polymyrcene, polydicyclopentadiene and the copolymers thereof), polyvinyl fluoride (PVF), polyvinylidene fluoride (PVDF), polytetrafluoroethylene (PTFE), are known to be difficult to bond to each other or to other types of substrates and often require surface treatment prior to bonding. This treatment may also be necessary in the case in which the substrate has to be coated or treated with a layer. This is because the surface of the substrate is chemically inert due to the saturated carbon-carbon bonds. These treatments, such as a plasma or corona treatment, an abrasion treatment or a treatment with a chemical agent, consist in chemically and/or physically modifying the surface of the substrate in order to favorably modify its surface energy.

However, this type of treatment has a certain number of disadvantages, such as a high process cost, results which are not necessarily reproducible, and an effect which diminishes over time.

Recently, it has been discovered that the use of adhesive compositions comprising organoboranes makes it possible to improve the adhesion of compounds comprising an ethylenic bond that can be polymerized by a radical route to low-energy surfaces. However, due to the unstable and pyrophoric nature of organoboranes, they must be complexed with an amine in order to limit their oxidative decomposition. This type of composition is often in the form of two parts (one of the two parts comprising the organoborane-amine complex and the other part comprising an agent which is reactive with the organoborane-amine complex such as a decomplexing agent) which are mixed just before the use and application of the composition. However, in some cases, despite complexing the organoborane with the amine, since the organoborane-amine complexes are highly reactive, this continues to present risks related to their handling and to the safety of operations. In order to overcome these drawbacks, excess amine can be used in order to reduce all these risks related to the safety of the products, even if this may generate an unpleasant odor, cause the amine to migrate to the surface and/or require special labeling.

Document U.S. Pat. No. 2,973,337 describes the polymerization of unsaturated compounds comprising one or more ethylenic bonds, using catalysts of borazane type.

Document U.S. Pat. No. 8,202,932 relates to polymerizable (meth)acrylic compositions and adhesive systems prepared from these compositions. These compositions comprise an alkylated borohydride or a tetraalkylborane metal or ammonium salt and an aminosilane. According to this document, these compositions are suitable for bonding applications involving at least one low-energy surface.

Document U.S. Pat. No. 6,632,908 relates to (meth)acrylic compositions used for the adhesion of metal, plastic or glass substrates to substrates of the same nature or of a different nature, such as substrates having a low-energy surface. The (meth)acrylic compositions described in this document comprise a (meth)acrylate compound and an initiator system comprising an organometallic compound, a peroxide compound, an aziridine-based compound and a compound having an acid function.

Document U.S. Pat. No. 9,315,701 describes a two-part adhesive composition comprising an organoborane-amine complex, a polyamine, a radically polymerizable compound and a polyisocyanate compound. These compositions are particularly suitable for the adhesion of substrates having a low surface energy.

Document WO 2016/077166 relates to a two-part composition comprising a first part comprising an organoborane-amine complex and a reactive diluent, and a second part comprising a decomplexing agent for decomplexing the organoborane-amine complex and at least one polymerizable compound comprising an ethylenic unsaturated bond.

Document WO 2014/140138 relates to a polymerizable composition comprising a polymerizable acrylate or methacrylate compound, an organoborane polymerization initiator compound, a vinyl ether compound, and an activator for the organoborane compound. The composition exhibits good storage stability and good adhesive properties, in particular when it is used for adhesion on low-energy surfaces.

Document US 2007/0135601 relates to complexes of organoboranes with amino-functional organosilyl compounds which are effective polymerization initiators for radical polymerization, in particular for acrylate and methacrylate adhesives. These complexes are particularly suitable for the adhesion of substrates having a low surface energy.

Document U.S. Pat. No. 6,008,308 describes a composition comprising an organoborane-polyamine complex, a polyol and an isocyanate compound.

The composition may also comprise a bifunctional compound comprising a radically polymerizable group and a group which is reactive with an amine.

This composition is used to initiate polymerization of an acrylic monomer and to form polyurethane/polyurea acrylic adhesives.

There is therefore a real need to provide a composition enabling good adhesion, in particular on and between substrates having a low surface energy, the composition being able to be used safely by avoiding the use of hazardous reagents and the associated drawbacks. There is also a real need to provide a composition enabling good adhesion, in particular on and between substrates having a low surface energy, the composition being devoid of decomplexing agents, in particular of decomplexing agents of isocyanate/polyisocyanate or succinic anhydride type. There is also a real need to provide a composition enabling good adhesion, in particular on and between substrates having a low surface energy, the composition not comprising excess amine.

### SUMMARY OF THE INVENTION

The invention relates first to a two-component composition comprising: a first part (A) comprising a borane BH₃-amine complex and an alkene compound, said alkene compound being chosen from:
an alkene compound of general formula [Chem 1]

H₂C═CH—R¹¹

R¹¹ representing a group comprising from 3 to 31 carbon atoms chosen from a linear or branched alkyl group, an aryl group, an arylalkyl group, a cycloalkyl group, an —OR¹² group, an —SR¹² group and an —SiR¹³R¹⁴R¹⁵ group; R¹² being chosen from a linear or branched alkyl group, an alkylaryl group, a cycloalkyl group, an acyl group;

R¹³, R¹⁴, R¹⁵ being chosen, independently of one another, from a linear or branched alkyl group, an aryl group, a cycloalkyl group or an alkoxy group; an alkene compound of general formula [Chem 2]

H₂C═CH—CH2-R¹¹

R¹¹ representing a group comprising from 3 to 31 carbon atoms chosen from a linear or branched alkyl group, an aryl group, an alkylaryl group, a cycloalkyl group, an —OR¹² group, an —SR¹² group and an —SiR¹³R¹⁴R¹⁵ group; R¹² being chosen from a linear or branched alkyl group, an arylalkyl group, a cycloalkyl group or an acyl group;

R¹³, R¹⁴, R¹⁵ being chosen, independently of one another, from a linear or branched alkyl group, an aryl group, a cycloalkyl group or an alkoxy group; and/or

an alkene compound of general formula [Chem 3]

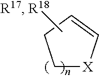

X being an oxygen atom, a sulfur atom or a bridge-forming —CH₂— divalent radical;

n being an integer from 2 to 10; and

R¹⁷ and R¹⁸ representing, independently of one another, a hydrogen atom, a linear or branched alkyl group comprising from 1 to 10 carbon atoms, a linear or branched alkene group comprising from 1 to 10 carbon atoms or a —CH₂-divalent radical forming a bridge with the ring; and

a second part (B) comprising at least one radically polymerizable compound comprising at least one ethylenic bond chosen from an acrylic monomer, a methacrylic monomer or a combination thereof.

In some embodiment, the amine is chosen from diisopropylamine, N-methyldiisopropylamine, N-ethyldiisopropylamine, dicyclohexylamine, N-methyldicyclohexylamine, N-ethyldicyclohexylamine, di-sec-butylamine, di-tert-butylamine, 1,1,1,3,3,3-hexamethyldisilazane, N-methyl-1,1,1,3,3,3-hexamethyldisilazane, N-ethyl-1,1,1,3,3,3-hexamethyldisilazane, 2,6-dimethylpiperidine, N-methyl-2,6-dimethylpiperidine, N-ethyl-2,6-dimethylpiperidine, 7-azabicyclo[2.2.1]heptane, N-ethyl-7-azabicyclo[2.2.1]heptane, 1-azabicyclo[2.2.2]octane and combinations thereof.

In some embodiments, the radically polymerizable compound is chosen from an acrylate, an acrylic acid, an acrylamide, an acrylonitrile, a methacrylate, a methacrylic acid, a methacrylamide, a methacrylonitrile, and combinations thereof.

In some embodiments, the alkene compound is chosen from decene, octene, allyltrimethylsilane, vinyltrimethoxysilane, vinyltriethoxysilane and combinations thereof.

In some embodiments, the borane BH₃-amine complex and the alkene compound are present in part (A) of the composition in a molar ratio of 1:1 to 1:20; preferentially from 1:3 to 1:10.

In some embodiments, the radically polymerizable compound has a weight content of 10% to 99%, preferentially from 30% to 95%, in part B of the composition.

In some embodiments, the volume ratio of part (A) to part (B) is from 1:1 to 1:40, preferentially from 1:1 to 1:10.

In some embodiments, said composition is devoid of decomplexing agents for decomplexing the borane and the amine, preferentially is devoid of isocyanate compound.

The invention relates secondly to an adhesive composition obtained by mixing parts (A) and (B) of the two-component composition as defined above.

The invention relates thirdly to the use of the two-component composition as defined above, or of the adhesive composition obtained therefrom as defined above, as an adhesive for binding two substrates together, or as a coating on the surface of a substrate, or as a primer on the surface of a substrate.

In some embodiments, the substrate or at least one of the two substrates has a surface energy of less than or equal to 45 mJ/m², preferentially of less than or equal to 40 mJ/m², very more preferentially of less than or equal to 35 mJ/m².

The invention relates fourthly to an article comprising at least one layer obtained by crosslinking the composition as defined above.

The present invention makes it possible to meet the needs expressed above. It more particularly provides a composition enabling good adhesion, in particular on and between substrates having a low surface energy, the composition being able to be used safely by avoiding the use of hazardous reagents and the associated drawbacks.

This is accomplished by virtue of the use of a two-component composition (or kit) comprising a borane-amine complex (i.e. BH₃-amine complex) and an alkene compound in a first part (part A), which makes it possible to avoid the use of commercial organoborane complexes which are pyrophoric and unstable. Since the borane-amine complex is more stable and less pyrophoric, the risks related to the safety of the process and the handling of hazardous products are limited.

Moreover, the present composition allows the polymerization of the (meth)acrylic acid monomers and the derivatives thereof without the use of reactive compounds such as decomplexing agents usually used to decomplex borane and amine. This makes it possible to facilitate the preparation of the adhesive composition.

Furthermore, the present invention enables the use of the complexes without the presence of excess amine, which makes it possible to reduce the problems of toxicity.

Advantageously, the two-component composition according to the present invention makes it possible to obtain adhesive compositions with higher adhesion to low surface energy substrates than that obtained with commercial organoborane complexes.

### DETAILED DESCRIPTION

The invention is now described in greater detail and in a nonlimiting manner in the description that follows.

The invention relates to a two-component composition comprising a first part (part A) and a second part (part B).

Borane-Amine Complex

The two-component composition, and more particularly part A of the two-component composition, comprises a complex of borane with an amine.

The term “borane”, or “trihydridoboron” according to systematic nomenclature, is understood to mean a molecule having the formula “BHs”.

Since borane is a highly reactive molecule, its complexation with an amine is necessary in order to ensure a good stability of the complex and of part A of the adhesive composition.

The amine may be a monoamine (comprising a single amine group) or a polyamine (comprising more than one amine group, for example two, three or four amine groups). In the case of polyamines comprising a main chain, the amine groups may be present at the ends of the main chain and/or in the form of side or pendant groups along the main chain.

Preferably, the amine is a monoamine.

When the amine is a monoamine, it can be chosen from a primary, secondary or tertiary monoamine, preferably a secondary or tertiary monoamine.

According to certain embodiments, the monoamine can be of general formula [Chem 4]:

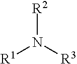

R¹, R² and R³ representing, independently of one another, a hydrogen atom, a silyl group, a group comprising from 1 to 20 carbon atoms, optionally comprising one or more heteroatoms chosen from oxygen, sulfur and nitrogen, the group being linear or branched and saturated or unsaturated and being chosen from an alkyl group, a cycloalkyl group, an arylalkyl group or an aryl group, or at least two of R¹, R² and R³ forming part of a cycloalkyl group. By way of example, R¹, R² and R³ may independently be a methyl group, an ethyl group, an n-propyl group, an isopropyl group, an n-butyl group, an isobutyl group, a sec-butyl group, a tert-butyl group, a cyclopropyl group, a cyclobutyl group, a cyclopentyl group, a cyclohexyl group, a benzyl group, a phenyl group which is substituted or not by one or more groups such as an alkyl (alkylaryl) or cycloalkyl group, an alkoxy group, a halogen, a nitro group, and an acyl group, a naphthyl group which is substituted or not by one or more groups such as an alkyl or cycloalkyl group, an alkoxy group, a halogen, a nitro group, and an acyl group, a heteroaryl group which is substituted or not by one or more groups such as an alkyl or cycloalkyl group, an alkoxy group, a halogen, a nitro group, and an acyl group. As examples of heteroaryl groups, mention may be made of pyridines, pyrroles and carbazoles. Alternatively, two of R¹, R² and R³ may form part of a ring, for example of a pyrrolidine, of a piperidine, of a morpholine, of a thiomorpholine, or of one of the higher homologs thereof. Still alternatively, at least two of R¹, R² and R³ may form part of several rings such as for example 1-azabicyclo[2.2.2]octane (or quinuclidine), 1,4-diazabicyclo[2.2.2]octane (or DABCO) and 7-azabicyclo[2.2.1]heptane.

According to certain embodiments, R¹, R² and R³ may independently be chosen from a silyl group. For example, this silyl group may comprise a silicon atom substituted by three carbon-based groups having from 1 to 10 carbon atoms, preferably from 1 to 5 carbon atoms and more preferably from 1 to 3 carbon atoms, and is linear or branched. These three groups can be independently chosen from an alkyl group, a cycloalkyl group, an arylalkyl group and an aryl group. Preferably, they are an alkyl group and even more preferably a methyl group.

Furthermore, according to certain embodiments, two of R¹, R² and R³ may be alkyl groups and the third of R¹, R² and R³ may be a hydrogen atom. One example of this type is 1,1,1,3,3,3-hexamethyldisilazane (or HMDS).

According to certain embodiments, R¹, R² and R³ may be identical.

According to other embodiments, R¹, R² and R³ may be different from one another.

According to certain embodiments, at least two of R¹, R² and R³ are identical.

According to certain embodiments, at least one of R¹, R² and R³ is a hydrogen. It is then a question of primary or secondary amines.

According to other embodiments, none of R¹, R² and R³ is a hydrogen. It is then a question of tertiary amines.

According to preferred embodiments, when the monoamine of formula [Chem 4] is a primary amine, it may be tert-butylamine.

According to preferred embodiments, when the monoamine of formula [Chem 4] is a secondary amine, it may be diisopropylamine or dicyclohexylamine, di-sec-butylamine, diisobutylamine, di-tert-butylamine, 1,1,1,3,3,3-hexamethyldisilazane, 2,6-dimethylpiperidine or 7-azabicyclo[2.2.1]heptane, and preferably diisopropylamine.

According to preferred embodiments, when the monoamine of formula [Chem 4] is a tertiary amine, it may be N-methyldiisopropylamine, N-ethyldiisopropylamine, N-methyldicyclohexylamine, N-ethyldicyclohexylamine, N-methyl-2,6-dimethylpiperidine, N-ethyl-2,6-dimethylpiperidine, 1-azabicyclo[2.2.2]octane (or quinuclidine), N-methyl-1,1,1,3,3,3-hexamethyldisilazane, N-ethyl-1,1,1,3,3,3-hexamethyldisilazane, N-methyl-7-azabicyclo[2.2.1]heptane or N-ethyl-7-azabicyclo[2.2.1]heptane, preferably N-methyldiisopropylamine, N-ethyldiisopropylamine, N-methyldicyclohexylamine, N-ethyldicyclohexylamine or N-methyl-2,6-dimethylpiperidine.

According to other embodiments, the monoamine may be a polyetheramine, i.e. an amine comprising multiple ether functions.

According to preferred embodiments, the monoamine is a primary polyetheramine.

According to other embodiments, the monoamine is a secondary or tertiary polyetheramine.

Thus, in the case of a monoamine which is a polyetheramine, it can be of general formula [Chem 5]:

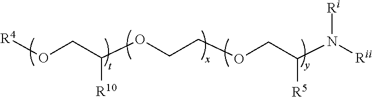

R⁴, R⁵ and R¹⁰ representing, independently of one another, a hydrogen atom or a group comprising from 1 to 10 carbon atoms, which is linear or branched, saturated or unsaturated and is chosen from an alkyl group, a cycloalkyl group, or an aryl group;

Rⁱ and Rⁱⁱ representing, independently of one another, a hydrogen atom or a group comprising from 1 to 20 carbon atoms, which is linear or branched, saturated or unsaturated and is chosen from an alkyl group, a cycloalkyl group, an aryl group or an arylalkyl group;

t, x and y representing, independently of one another, an integer from 0 to 90, preferentially from 0 to 70, very preferentially from 0 to 50, more preferentially from 0 to 30.

According to certain embodiments, R⁴ may be chosen from an alkyl group, a cycloalkyl group, an arylalkyl group, an aryl group, or an alkylaryl group, the alkyl, cycloalkyl, arylalkyl, aryl and alkylaryl groups being as described above.

Preferably, R⁴ is an alkyl group, preferably comprising from 1 to 7 carbon atoms, and preferably from 1 to 3 carbon atoms.

According to certain embodiments, R⁵ may be chosen from an alkyl group, a cycloalkyl group or an aryl group, these groups being as described above.

Preferably, R⁵ is an alkyl group, in particular a group comprising from 1 to 2 carbon atoms. More preferably, R⁵ is chosen from a methyl group and an ethyl group.

According to certain embodiments, R¹⁰ may be chosen from an alkyl group, a cycloalkyl group, or an aryl group, the alkyl, cycloalkyl and aryl groups being as described above. Preferably, R¹⁰ is an alkyl group, in particular a group comprising from 1 to 2 carbon atoms. More preferably, R¹⁰ is chosen from a methyl group and an ethyl group.

According to certain preferred embodiments, R⁴, R⁵ and R¹⁰ may be identical.

According to other embodiments, R⁴, R⁵ and R¹⁰ may be different from one another.

According to preferred embodiments, R⁵ and R¹⁰ are different from one another. For example, one of R⁵ and R¹⁰ may be an ethyl group and the other of R⁵ and R¹⁰ may be a methyl group.

According to preferred embodiments, at least one of R⁴, R⁵ and R¹⁰ is a methyl group.

Rⁱ and Rⁱⁱ may independently represent a hydrogen atom or a group comprising from 1 to 20 carbon atoms. This group may be linear or branched, saturated or unsaturated.

According to certain embodiments, Rⁱ and Rⁱⁱ may independently be chosen from an alkyl group, a cycloalkyl group, an aryl group or an arylalkyl group.

By way of example, Rⁱ and Rⁱⁱ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkylphenyl, a phenyl group which is substituted or not by one or more groups such as an alkyl or cycloalkyl group, an alkoxy group, a halogen, a nitro group, and an acyl group, a naphthyl group which is substituted or not by one or more groups such as an alkyl or cycloalkyl group, an alkoxy group, a halogen, a nitro group, and an acyl group, a heteroaryl group which is substituted or not by one or more groups such as an alkyl or cycloalkyl group, an alkoxy group, a halogen, a nitro group, and an acyl group. As examples of heteroaryl groups, mention may be made of pyridines, pyrroles and carbazoles. Alternatively, Rⁱ and Rⁱⁱ may form part of a ring, for example of a pyrrolidine, of a piperidine, of a morpholine, of a thiomorpholine, or of one of the higher homologs thereof.

According to certain preferred embodiments, Rⁱ and Rⁱⁱ are both hydrogen atoms. In this case, it is a primary polyetheramine.

According to other embodiments, at least one of Rⁱ and Rⁱⁱ is a group comprising from 1 to 20 carbon atoms. In this case, it is a secondary polyetheramine.

According to other embodiments, both of Rⁱ and Rⁱⁱ are independently groups comprising from 1 to 20 carbon atoms. In this case, it is a tertiary polyetheramine.

According to certain embodiments, t, x and y may independently represent a number from 0 to 90, preferentially from 0 to 70, preferentially from 0 to 50, and even more preferentially from 0 to 30. Thus, t, x and y may independently represent a number from 0 to 10, or from 10 to 20; or from 20 to 30; or from 30 to 40; or from 40 to 50; or from 50 to 60; or from 60 to 70; or from 70 to 80; or from 80 to 90.

When t is other than 0, the number t represents the number of ethoxy groups substituted by a group R¹⁰ (preferably propoxy groups when R¹⁰ is methyl or butoxy groups when R¹⁰ is ethyl) present in the monoamine of formula [Chem 5].

The number t may or may not be an integer. For example, if a mixture of different alkylene oxides is used, t corresponds to the average degree of ethoxylation of the ethoxy groups substituted by a group R¹⁰ (preferably to the average degree of propoxylation when R¹⁰ is methyl or butoxylation when R¹⁰ is ethyl).

When x is other than 0, the number x represents the number of ethoxy groups present in the monoamine of formula [Chem 5].

The number x may or may not be an integer. For example, if a mixture of different alkylene oxides is used, x corresponds to the average degree of ethoxylation.

When y is other than 0, the number y represents the number of ethoxy groups substituted by a group R⁵ (preferably propoxy groups when R⁵ is methyl or butoxy groups when R⁵ is ethyl) present in the monoamine of formula [Chem 5].

The number y may or may not be an integer. For example, if a mixture of different alkylene oxides is used, y corresponds to the average degree of ethoxylation of the ethoxy groups substituted by a group R⁵ (preferably to the average degree of propoxylation when R⁵ is methyl or butoxylation when R⁵ is ethyl).

When t and y are other than 0, the sum t+y represents the number of ethoxy groups substituted by groups R⁵ and R¹⁰ (preferably propoxy groups when R⁵ and R¹⁰ are methyl or butoxy groups when R⁵ and R¹⁰ are ethyl) present in the amine of formula [Chem 5].

According to certain embodiments, when t is equal to 0, y is other than 0.

According to other embodiments, when y is equal to 0, t is other than 0.

According to yet other embodiments, in particular when R⁵ and R¹⁰ are different, t and y are both other than 0.

According to certain embodiments, when y and/or t is equal to 0, x is other than 0.

According to other embodiments, when x is equal to 0, y and/or t is other than 0.

The monoamines of formula [Chem 5] may have a molecular weight of 200 to 5500 g/mol, and preferably of 500 to 2500 g/mol. For example, the monoamines of formula [Chem 5] may have a molecular weight of 200 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol.

This type of polyetheramine is for example sold under the name Jeffamine M series by the company Huntsman.

When the amine is a polyamine, it may be chosen from a primary and/or secondary and/or tertiary polyamine. Preferably, it is a primary polyamine, i.e. all of its amine groups are primary amine groups. More preferably, it is a diamine. However, polyamines comprising more than two amine groups (for example three or four) such as polyethyleneimines (PEIs) may be used.

According to certain embodiments, the polyamine can be of general formula [Chem 6]:

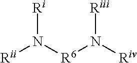

R⁶ representing a divalent group comprising from 2 to 60 carbon atoms, preferentially from 2 to 40 carbon atoms, optionally comprising one or more heteroatoms chosen from oxygen and sulphur, the group being linear or branched, saturated or unsaturated, and being chosen from a divalent alkyl radical, a divalent cycloalkyl radical, a divalent arylalkyl radical or a divalent aryl radical; Rⁱ, Rⁱⁱ, Rⁱⁱⁱ and R^{iv} representing, independently of one another, a hydrogen atom or a group comprising from 1 to 20 carbon atoms, which is linear or branched, saturated or unsaturated, and is chosen from an alkyl group, a cycloalkyl group, an aryl group or an arylalkyl group.

R⁶ may represent a divalent group comprising from 2 to 60 carbon atoms, preferably from 2 to 40 carbon atoms and more preferably from 2 to 15 carbon atoms.

R⁶ may be linear or branched, cyclic or alicyclic, saturated or unsaturated.

R⁶ may comprise one or more heteroatoms such as an oxygen atom, a sulfur atom, a nitrogen atom or a halogen. Preferably, a single heteroatom may be present in R⁶.

In addition, R⁶ may be chosen from a divalent alkyl radical, a divalent cycloalkyl radical, a divalent alicyclic radical, a divalent arylalkyl radical or a divalent aryl radical. Preferably, R⁶ is an alkyl group.

Rⁱ and Rⁱⁱ are as detailed above.

Rⁱⁱⁱ and R^{iv} may independently represent a hydrogen atom or a group comprising from 1 to 20 carbon atoms. This group may be linear or branched, saturated or unsaturated.

According to certain embodiments, Rⁱⁱⁱ and R^{iv} may independently be chosen from an alkyl group, a cycloalkyl group, an aryl group, or an arylalkyl group.

By way of example, Rⁱⁱⁱ and R^{iv} may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkylphenyl, a phenyl group which is substituted or not by one or more groups such as an alkyl or cycloalkyl group, an alkoxy group, a halogen, a nitro group, and an acyl group, a naphthyl group which is substituted or not by one or more groups such as an alkyl or cycloalkyl group, an alkoxy group, a halogen, a nitro group, and an acyl group, a heteroaryl group which is substituted or not by one or more groups such as an alkyl or cycloalkyl group, an alkoxy group, a halogen, a nitro group, and an acyl group. As examples of heteroaryl groups, mention may be made of pyridines, pyrroles and carbazoles. Alternatively, Rⁱⁱⁱ and R^{iv} may form part of a ring, for example of a pyrrolidine, of a piperidine, of a morpholine, of a thiomorpholine, or of one of the higher homologs thereof.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to preferred embodiments, the polyamine of formula [Chem 6] may be chosen from ethylenediamine, 1,3-propanediamine, 1,5-pentanediamine, 1,6-hexanediamine, 1,12-dodecanediamine, 2-methyl-1,5-pentanediamine, 3-methyl-1,5-pentanediamine, isophoronediamine, 4,4′-methylenedianiline, 2-methylbenzene-1,4-diamine, diethylenetriamine, 4,6-diethyl-2-methylbenzene-1,3-diamine, 4,4′-methylenedicyclohexanamine, 2,4,6-trimethyl-1,3-phenylenediamine, and naphthalene-1,8-diamine.

More preferably, the polyamine of formula [Chem 6] may be chosen from ethylenediamine and 1,3-propanediamine, and preferably the polyamine of formula [Chem 6] is 1,3-propanediamine.

According to other embodiments, the polyamine may be a polyetheramine comprising two amine groups, preferably primary amine groups. Alternatively, the polyamine may be a secondary or tertiary polyamine comprising two amine groups.

Thus, when it is a polyetheramine comprising two amine groups, it can be of general formula [Chem 7]:

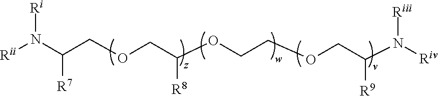

R⁷, R⁸ and R⁹ representing, independently of one another, a group comprising from 1 to 10 carbon atoms, which is linear or branched, saturated or unsaturated and is chosen from an alkyl group, a cycloalkyl group, or an aryl group;

Rⁱ, Rⁱⁱ, Rⁱⁱⁱ and R^{iv} representing, independently of one another, a hydrogen atom or a group comprising from 1 to 20 carbon atoms, which is linear or branched, saturated or unsaturated, and is chosen from an alkyl group, a cycloalkyl group, an aryl group or an arylalkyl group;

v, w and z representing, independently of one another, a number from 0 to 90, preferably from 0 to 70.

R⁷, R⁸ and R⁹ may independently represent a group comprising from 1 to 10 carbon atoms, preferably from 1 to 6 carbon atoms, and more preferably from 1 to 2 carbon atoms. These groups may be linear or branched, saturated or unsaturated.

R⁷, R⁸ and R⁹ may independently be chosen from an alkyl group, a cycloalkyl group, or an aryl group, these groups being as described above. Preferably, at least one of R⁷, R⁸ and R⁹ is an alkyl group, and more preferably a methyl group or an ethyl group.

According to certain preferred embodiments, R⁷, R⁸ and R⁹ may be identical.

According to other embodiments, R⁷, R⁸ and R⁹ may be different from one another.

According to preferred embodiments, at least one of R⁷, R⁸ and R⁹ is a methyl group, and preferably R⁷, R⁸ and R⁹ are methyl groups.

According to preferred embodiments, R⁸ and R⁹ are different from one another.

According to other embodiments, at least one of R⁸ and R⁹ are methyl groups, and the other of R⁸ and R⁹ ethyl groups.

Rⁱ, Rⁱⁱ, Rⁱⁱⁱ and R^{iv} are as detailed above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to certain embodiments, v, w and z may independently represent a number from 0 to 90, preferentially from 0 to 70. Thus, v, w and z may independently represent a number from 0 to 10, or from 10 to 20; or from 20 to 30; or from 30 to 40; or from 40 to 50; or from 50 to 60; or from 60 to 70; or from 70 to 80; or from 80 to 90.

According to certain embodiments, z is equal to 0 and v is other than 0.

According to other embodiments, z is other than 0 and v is equal to 0.

According to yet other embodiments, z and v are both other than 0.

When z and v are other than 0, the sum z+v represents the number of substituted ethoxy groups (preferably propoxy or butoxy groups) present in the polyamine of formula [Chem 7].

The sum z+v may or may not be an integer. For example, if a mixture of different alkylene oxides is used, z+v corresponds to the average degree of ethoxylation of the ethoxy groups substituted by R⁸ and R⁹ (preferably to the degree of propoxylation or butoxylation).

When v is equal to 0, the number z represents the number of ethoxy groups substituted by R⁸ (preferably propoxy groups when R⁸ is methyl or butoxy groups when R⁸ is ethyl) present in the polyamine of formula [Chem 7].

When z is equal to 0, the number v represents the number of ethoxy groups substituted by R⁹ (preferably propoxy groups when R⁹ is methyl or butoxy groups when R⁹ is ethyl) present in the polyamine of formula [Chem 7].

The numbers z and v may or may not be integers.

The number w represents the number of ethoxy groups present in the polyamine.

The number w may or may not be an integer. For example, if a mixture of different molecules is used, w corresponds to the average degree of ethoxylation.

According to certain embodiments, v and w may be 0. This type of polyetheramine is for example sold under the names Jeffamine D series and Jeffamine SD series by the company Huntsman.

According to other embodiments, w may be equal to 0, while v is greater than 0.

According to other embodiments, v and w may be greater than 0.

This type of polyetheramine is for example sold under the name Jeffamine ED series by the company Huntsman.

The polyetheramines of formula [Chem 7] may have a molecular weight of 100 to 5000 g/mol, preferably of 200 to 4000 g/mol, preferably of 200 to 2000 g/mol and preferably of 200 to 1000 g/mol. For example, the polyetheramines of formula [Chem 7] may have a molecular weight of 100 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol.

According to other embodiments, the polyetheramine comprising two amine groups can be of general formula [Chem 8]:

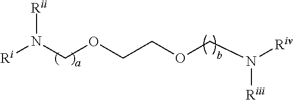

Rⁱ, Rⁱⁱ, Rⁱⁱⁱ and R^{iv} representing, independently of one another, a hydrogen atom or a group comprising from 1 to 20 carbon atoms, which is linear or branched, saturated or unsaturated, and is chosen from an alkyl group, a cycloalkyl group, an aryl group or an arylalkyl group;

a and b represent, independently of one another, an integer from 1 to 20, preferentially from 2 to 11.

Rⁱ, Rⁱⁱ, Rⁱⁱⁱ and R^{iv} are as described above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to certain embodiments, a and b may independently represent a number from 1 to 20 and preferably from 2 to 11.

According to certain preferred embodiments, a and b are identical.

Preferably, a and b are equal to 2 or 3.

According to other embodiments, a and b are different. In this case, at least one of a and b is preferably equal to 2 or 3.

The polyetheramines of formula [Chem 8] may have a molecular weight of 150 to 1500 g/mol, preferably of 150 to 1000 g/mol and preferably of 150 to 500 g/mol. For example, the polyetheramines of formula [Chem 8] may have a molecular weight of 150 to 160 g/mol; or of 160 to 170 g/mol; or of 170 to 180 g/mol; or of 180 to 190 g/mol; or of 190 to 200 g/mol; or of 200 to 300 g/mol; or of 300 to 400 g/mol; or of 400 to 500 g/mol; or of 500 to 600 g/mol; or of 600 to 700 g/mol; or of 700 to 800 g/mol; or of 800 to 900 g/mol; or of 900 to 1000 g/mol; or of 1000 to 1100 g/mol; or of 1100 to 1200 g/mol; or of 1200 to 1300 g/mol; or of 1300 to 1400 g/mol; or of 1400 to 1500 g/mol.

This type of polyetheramine of formula [Chem 8] is for example sold under the name Jeffamine EDR series by the company Huntsman.

According to other embodiments, the polyamine may be a primary polyetheramine comprising three amine groups. Alternatively, the polyamine may be a secondary or tertiary polyamine comprising three amine groups.

Thus, when it is a polyetheramine comprising three amine groups, it can be of general formula [Chem 9]:

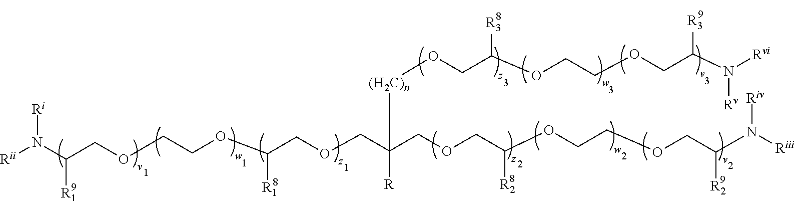

R₁⁸, R₁⁹, R₂⁸, R₂⁹, R₂⁹, R₃⁸, and R₃⁹ representing, independently of one another, a group comprising from 1 to 10 carbon atoms, which is linear or branched, and is chosen from an alkyl group, a cycloalkyl group, or an aryl group;

R representing a hydrogen atom or a group comprising from 1 to 10 carbon atoms, which is linear or branched, saturated or unsaturated and is chosen from an alkyl group, a cycloalkyl group, an arylalkyl group or an aryl group; Rⁱ, Rⁱⁱ, Rⁱⁱⁱ and R^{iv} representing, independently of one another, a hydrogen atom or a group comprising from 1 to 20 carbon atoms, which is linear or branched, and is chosen from an alkyl group, a cycloalkyl group, an aryl group or an arylalkyl group;

n representing an integer from 0 to 30, preferentially equal to 0 or 1; and the sums z₁+z₂+z₃, v₁+v₂+v₃ and w₁+w₂+w₃ representing, independently of one another, an integer from 0 to 90, preferentially from 0 to 70, very preferentially from 0 to 50 and more preferentially from 0 to 30.

R₁⁸, R₁⁹, R₂⁸, R₂⁹, R₂⁹, R₃⁸, and R₃⁹ may independently represent a group comprising from 1 to 10 carbon atoms, preferably from 1 to 6 carbon atoms, and more preferably from 1 to 2 carbon atoms. These groups may be linear or branched, saturated or unsaturated.

R₁⁸, R₁⁹, R₂⁸, R₂⁹, R₂⁹, R₃⁸, and R₃⁹ may independently be chosen from an alkyl group, a cycloalkyl group, or an aryl group, these groups being as described above. Preferably, at least one of R₁⁸, R₁⁹, R₂⁸, R₂⁹, R₂⁹, R₃⁸, and R₃⁹ is an alkyl group. More preferably R₁⁸, R₁⁹, R₂⁸, R₂⁹, R₂⁹, R₃⁸, and R₃⁹ are chosen from a methyl group or an ethyl group.

According to certain preferred embodiments, R₁⁸, R₁⁹, R₂⁸, R₂⁹, R₂⁹, R₃⁸, and R₃⁹ may be identical, for example they are all a methyl group.

According to other embodiments, R₁⁸, R₁⁹, R₂⁸, R₂⁹, R₂⁹, R₃⁸, and R₃⁹ may be different from one another.

According to certain embodiments, R₁⁸ is different from R₂⁸ and/or R₃⁹.

According to certain embodiments, R₁⁹ is different from R₂⁹ and/or R₃⁹.

According to preferred embodiments, at least one of R₁⁸, R₁⁹ and/or at least one of R₂⁸, R₂⁹ and/or at least one of R₃⁸, R₃⁹ and/or is a methyl group and the other of R₁⁸, R₁⁹ and/or R₂⁸, R₂⁹ and/or R₃⁸, R₃⁹ and/or is an ethyl group.

R may represent a hydrogen atom or a group comprising from 1 to 10 carbon atoms, and preferably from 1 to 3 carbon atoms. This group may be linear or branched.

According to certain embodiments, R may be chosen from an alkyl group, a cycloalkyl group, an arylalkyl group, or an aryl group, the alkyl, cycloalkyl, arylalkyl and aryl groups being as described above.

When R is a group comprising from 1 to 10 carbon atoms, it is preferably an alkyl group, preferably comprising from 1 to 3 carbon atoms, and preferably from 1 to 2 carbon atoms.

According to certain embodiments, R is a hydrogen atom.

According to other embodiments, R is an ethyl group.

Rⁱ, Rⁱⁱ, Rⁱⁱⁱ and R^{iv} are also as detailed above.

According to certain embodiments, z₁, z₂ and z₃ may represent a number from 0 to 80, and preferably from 0 to 70. For example, z₁, z₂ and z₃ may be from 0 to 5; or from 5 to 10; or from 10 to 15; or from 15 to 20; or from 20 to 25; or from 25 to 30; or from 30 to 35; or from 35 to 40; or from 40 to 45; or from 45 to 50; or from 50 to 55; or from 55 to 60; or from 60 to 65; or from 65 to 70; or from 70 to 75; or from 75 to 80. The numbers z₁, z₂ and z₃ may or may not be an integer.

According to certain embodiments, w₁, w₂ and w₃ may represent a number from 0 to 50, and preferably from 0 to 40. For example, w₁, w₂ and w₃ may be from 0 to 5; or from 5 to 10; or from 10 to 15; or from 15 to 20; or from 20 to 25; or from 25 to 30; or from 30 to 35; or from 35 to 40. The numbers w₁, w₂ and w₃ may or may not be an integer.

According to certain embodiments, v₁, v₂ and v₃ may represent a number from 0 to 20, and preferably from 0 to 10. For example, v₁, v₂ and v₃ may be from 0 to 2; or from 2 to 4; or from 4 to 6; or from 6 to 8; or from 8 to 10; or from 10 to 12; or from 12 to 14; or from 14 to 16; or from 16 to 18; or from 18 to 20. The numbers v₁, v₂ and v₃ may or may not be an integer.

According to certain embodiments, at least one of z₁, z₂ and z₃ is other than 0.

According to certain embodiments, at least one of v₁, v₂ and v₃ is other than 0.

According to other embodiments, at least one of z₁, z₂ and z₃ is other than 0, and v₁, v₂ and V3 are equal to 0.

According to certain embodiments, at least one of w₁, w₂ and w₃ is other than 0.

According to other embodiments, at least one of w₁, w₂ and w₃ is equal to 0, and preferably at least two of w₁, w₂ and w₃ and preferably all three of w₁, w₂ and w₃ are equal to 0.

According to certain embodiments, at least one of v₁ and z₁ is equal to 0 and/or at least one of v₂ and z₂ is equal to 0 and/or at least one of v₃ and z₃ is equal to 0.

According to preferred embodiments, at least one of v₁ and z₁ is equal to 0 and/or at least one of v₂ and z₂ is equal to 0 and/or at least one of v₃ and z₃ is equal to 0 and at least one of w₁, w₂ and w₃ is equal to 0, and preferably at least two of w₁, w₂ and w₃ and preferably all three of w₁, w₂ and w₃ are equal to 0.

The sum w₁+w₂+w₃ represents the number of ethoxy groups present in the polyamine of formula [Chem 9].

The sum v₁+v₂+v₃+z₁+z₂+z₃ represents the number of ethoxy groups substituted by R₁⁸, R₁⁹, R₂⁸, R₂⁹, R₃⁸ and R₃⁹ (preferably propoxy or butoxy groups) present in the polyamine of formula [Chem 9].

The sum v₁+v₂+v₃+z₁+z₂+z₃ may or may not be an integer. For example, if a mixture of different alkylene oxides is used, this sum corresponds to the average degree of ethoxylation of the ethoxy groups substituted by R₁⁸, R₁⁹, R₂⁸, R₂⁹, R₃⁸ and R₃⁹ (preferably to the degree of propoxylation and/or butoxylation).

The sums z₁+z₂+z₃, v₁+v₂+v₃ and w₁+w₂+w₃ may independently represent a number from 0 to 90, preferentially from 0 to 70, preferentially from 0 to 50 and even more preferentially from 0 to 30. Thus, this number may be from 0 to 10; or from 10 to 20; or from 20 to 30; or from 30 to 40; or from 40 to 50; or from 50 to 60; or from 60 to 70; or from 70 to 80; or from 80 to 90.

According to certain embodiments, when w₁, w₂, w₃, z₁, z₂ and z₃ are equal to 0, v₁+v₂+v₃ may be from 2 to 90, and preferably from 4 to 90. For example, this sum may be from 2 to 5; or from 5 to 10; or from 10 to 20; or from 20 to 30; or from 30 to 40; or from 40 to 50; or from 50 to 60; or from 60 to 70; or from 70 to 80; or 80 to 90.

The number n may represent a number from 0 to 30, preferably from 1 to 20, and more preferably from 1 to 10. For example, n may be from 0 to 5; or from 5 to 10; or from 10 to 15; or from 15 to 20; or from 20 to 25; or from 25 to 30. According to certain preferred embodiments, n may be 0 or 1.

The polyetheramines of formula [Chem 9] may have a molecular weight of 300 to 6000 g/mol, preferably of 300 to 5000 g/mol, preferably of 300 to 4000 g/mol and preferably of 300 to 3000 g/mol. For example, the polyetheramines of formula [Chem 9] may have a molecular weight of 300 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol; or of 5500 to 5750 g/mol; or of 5750 to 6000 g/mol.

This type of polyetheramine of formula [Chem 9] is for example sold under the names Jeffamine T series and Jeffamine ST series by the company Huntsman.

In all of the formulae above, the groups with indices t, x, y, v, w, z, vᵢ, wᵢ, and zᵢ, may or may not be adjacent in the molecule. For example, ethoxy groups may alternate randomly (according to a certain statistical distribution) with propoxy and/or butoxy groups along the same chain.

Alternatively, other types of polyamines that may be used in the context of the present invention are polyethyleneimines (or polyaziridines), that is to say a polymer comprising a repeating unit composed of the amine group and of the biradical “—CH₂CH₂—” group. These polyamines may be linear, branched or dendrimers. Examples include tetraethylenepentamine, EPOMIN SP012 and also the polyethyleneimines of the Lupasol® name (in particular Lupasol® FG) sold by the company BASF.

According to the invention, the borane can form a complex with the amine, with a molar ratio of borane to the amine of 0.1 to 10, preferentially of 0.5 to 5, very preferentially of 0.5 to 2. This ratio may in particular be from 0.1 to 0.5; or from 0.5 to 1; or from 1 to 2; or from 2 to 4; or from 4 to 5 or from 5 to 6; or from 6 to 8; or from 8 to 10. For example, when a monoamine is involved, this ratio is preferably approximately 1. However, when a diamine is involved, this ratio is preferably approximately 2.

The borane-amine complex may be added to part A of the composition at a weight content of 5% to 50%, and preferably of 8% to 45%, relative to the total weight of part A of the composition. This complex can for example be added at a weight content of from 5% to 10%; or from 10% to 15%; or from 15% to 20%; or from 20% to 25%; or from 25% to 30%; or from 30% to 35%; or from 35% to 40%; or from 40% to 45%; or from 45% to 50%.

According to preferred embodiments, the borane-amine complex may be prepared before it is introduced into part A of the composition. This preparation may be carried out according to the process described in patent application EP 2189463 filed on Mar. 30, 2009 or according to the process described in the article by P. Veeraraghavan Ramachandran et al. (“Amine-boranes bearing borane-incompatible functionalities: application to selective amine protection and surface functionalization”, Chem. Commun., 2016, 52, 11885), which are incorporated by reference, for example by reacting an amine as described above with a borohydride compound, such as sodium borohydride, potassium borohydride or lithium borohydride. This reaction may in particular be carried out in the presence of an acid such as an inorganic acid such as sulfuric acid, methanesulfonic acid, hydrochloric acid, nitric acid, boric acid, and preferably in the presence of sulfuric acid.

Alkene Compound

Part A of the two-component composition comprises an alkene compound. This alkene compound can react with the borane BH₃-amine complex to form an organoborane in situ. The term “organoborane” is understood to mean a compound comprising at least one boron atom bonded to at least one carbon atom by hydroboration. In part A of the two-component composition, the borane BH₃-amine complex and the alkene compound may be present in a molar ratio of 1:1 to 1:20; preferentially from 1:3 to 1:10. For example, the borane BH₃-amine complex and the alkene compound may be present in a molar ratio of 1:1 to 1:5; or from 1:5 to 1:10; or from 1:10 to 1:15; or from 1:15 to 1:20.

According to certain embodiments, the alkene compound may be of general formula [Chem 1]:

H₂C═CH—R¹¹

R¹¹ represents a group comprising from 3 to 31 carbon atoms. This group may be linear or branched. In addition, this group can be chosen from an alkyl group, a cycloalkyl group, an aryl group, an arylalkyl group such as a phenylalkyl group, a phenyl group substituted or not by one or more groups such as an alkyl group (alkylaryl), a —OR¹² grouping, an —SR¹² group or a —SiR¹³R¹⁴R¹⁵ group.

When R¹¹ represents an alkyl group, this group may be devoid of heteroatoms. In other words, the alkyl group can consist of carbon atoms and hydrogen atoms. It may be for example an n-propyl group, an isopropyl group, an n-butyl group, a sec-butyl group, an isobutyl group, a tert-butyl group, a (linear, cyclic or branched) pentyl group, a (linear, cyclic or branched) hexyl group, a (linear, cyclic or branched) heptyl group, a (linear, cyclic or branched) octyl group, a (linear, cyclic or branched) nonyl group, a (linear, cyclic or branched) decyl group, a (linear, cyclic or branched) undecyl group, a (linear, cyclic or branched) dodecyl group, a (linear, cyclic or branched) tridecyl group, a (linear, cyclic or branched) tetradecyl group, a (linear, cyclic or branched) pentadecyl group, a (linear, cyclic or branched) hexadecyl group, a (linear, cyclic or branched) heptadecyl group, a (linear, cyclic or branched) octadecyl group, a (linear, cyclic or branched) nonadecyl group, a (linear, cyclic or branched) eicosanyl group, a (linear, cyclic or branched) heneicosanyl group, a (linear, cyclic or branched) docosanyl group or the mixtures thereof such as the linear and branched C20-24 Alpha Olefins available from INEOS OLIGOMERS or the Linear Alpha Olefins available from IDEMITSU KOSAN under the commercial reference LINEALENE.

Alternatively, when R¹¹ represents an alkyl group, this group may comprise at least one heteroatom, in particular an oxygen atom and/or a sulfur atom or and/or a silicon atom and/or a halogen chosen from fluorine, chlorine, bromine and iodine atoms. For example, it may be a linear alkyl chain which comprises a heteroatom group as an end group or as a divalent radical (that is to say present in the alkyl chain between two alkyl groups) or as a side group on the alkyl chain. In this case, the alkene compound can have one of the following formulae:

H₂C═CH—(CH₂)ₘ—O—R¹⁹ General formula [Chem 10]

In the formula [Chem 10], m may be from 1 to 9, and R¹⁹ may be a group comprising from 1 to 22 carbon atoms, this group possibly being linear or branched. R¹⁹ may be an alkyl group, an aryl group, an alkylaryl group or a cycloalkyl group, these groups being as described below.

The aryl group may be for example a phenyl group, a substituted phenyl group (see alkylaryl below) or a heteroaryl group such as a pyridine, a pyrrole, or a carbazole. The alkyl, alkylaryl and cycloalkyl groups are as described below.

H₂C═CH—(CH₂)ₜ—O—[CH₂—CH(R²⁰)—O]ₒ—R²¹ General formula [Chem 11]

In the formula [Chem 11], r may be from 1 to 9, o may be from 1 to 340 and R²⁰ may be a hydrogen atom or a group comprising from 1 to 6 carbon atoms, this group possibly being linear or branched. R²¹ may be a group comprising from 1 to 22 carbon atoms, this group being linear, cyclic or branched. R²¹ may be an alkyl group, a cycloalkyl group, an alkylaryl group or an aryl group, these groups being as described above.

H₂C═CH—(CH₂)ₚ—COOR²² General formula [Chem 12]

In the formula [Chem 12], p may be from 1 to 8, and R²² may be a group comprising from 1 to 22 carbon atoms, this group possibly being linear or branched. R²² may be an alkyl group, a cycloalkyl group, an arylalkyl group or an aryl group, these groups being as described above.

H₂C═CH—(CH₂)_{q}—SiR¹³R¹⁴R¹⁵ General formula [Chem 13]

In the formula [Chem 13], q may be from 1 to 9, and the groups R¹³, R¹⁴ and R¹⁵ may be chosen, independently of one another, from a linear or branched alkyl group, a cycloalkyl group, an arylalkyl group, an aryl group or an alkoxy group. These groups may comprise from 1 to 20, preferably from 1 to 10, and more preferably from 1 to 5 carbon atoms and they may be (independently of one another) linear or branched groups.

According to certain embodiments, at least one of R¹³, R¹⁴ and R¹⁵, preferably at least two of R¹³, R¹⁴ and R¹⁵, and more preferably the three groups R¹³, R¹⁴ and R¹⁵ are alkoxy groups, such as for example a methoxy group, an ethoxy group, a propoxy group or a butoxy group.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an isopropyl group, an n-butyl group, an isobutyl group, a sec-butyl group or a tert-butyl group.

H₂C═CH—(CH₂)ᵣ—O—(CH₂)ₛ—SiR¹³R¹⁴R¹⁵ General formula [Chem 14]

In the formula [Chem 14], r may be as described above, s may be from 2 to 11 carbon atoms, and the groups R¹³, R¹⁴ and R¹⁵ may be as described above. According to certain embodiments, at least one of R¹³, R¹⁴ and R¹⁵, preferably at least two of R¹³, R¹⁴ and R¹⁵, and more preferably the three groups R¹³, R¹⁴ and R¹⁵ are alkoxy groups, such as for example a methoxy group, an ethoxy group, a propoxy group or a butoxy group.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an n-propyl group, an isopropyl group, an n-butyl group, an isobutyl group, a sec-butyl group or a tert-butyl group.

H₂C═CH—(CH₂)ₖ-Hal General formula [Chem 15]

In the formula [Chem 15], k may be from 3 to 30, and Hal may be a halogen chosen from fluorine, chlorine, bromine and iodine atoms. Preferably, the halogen is bromine.

When R¹¹ represents an aryl group, it may be for example a phenyl group, a substituted phenyl group (see alkylaryl below) or a heteroaryl group such as a pyridine, a pyrrole, or a carbazole.

When R¹¹ represents an alkylaryl group, it may be an aryl group substituted by one or more groups, these groups preferably being alkyl groups comprising from 1 to 10, and preferably from 1 to 5 carbon atoms, such as a methyl group, an ethyl group, an n-propyl group, an isopropyl group, a cyclopropyl group, a tert-butyl group, an isobutyl group, an n-butyl group or a sec-butyl group.

When R¹¹ is an arylalkyl group, it may be an alkyl group substituted by one or more aryl groups, these groups preferably being aryl groups comprising from 4 to 10, and preferably from 4 to 6 carbon atoms, such as a furanyl group or a phenyl group.

When R¹¹ represents a cycloalkyl group, it may be a cyclopropyl group, a cyclobutyl group, a cyclopentyl group, or a cyclohexyl group. It may also be a cycloalkyl substituted by one or more groups, these groups preferably being alkyl groups comprising from 1 to 10, and preferably from 1 to 5 carbon atoms, such as a methyl group, an ethyl group, an n-propyl group, an isopropyl group, an n-butyl group, an isobutyl group, a sec-butyl group or a tert-butyl group.

When R¹¹ represents an —OR¹² group, the R¹² group is chosen from a linear or branched alkyl group (comprising from 3 to 30 carbon atoms), a cycloalkyl group, an arylalkyl group or an acyl group.

Thus, according to certain embodiments, the R¹² group may be free of heteroatoms. In other words, the alkyl group can consist of carbon atoms and hydrogen atoms.

The arylalkyl group is as described above.

The cycloalkyl group is as described above.

According to other embodiments, the R¹² group may comprise one or more heteroatoms, preferably oxygen atoms. Thus, the R¹² group may comprise an acyl group such as a —COOR¹⁶ group. In this case R¹⁶ can be chosen from a linear or branched alkyl group, a cycloalkyl group, or an arylalkyl group.

When R¹¹ represents an —SR¹² group, the R¹² group is chosen from a linear or branched alkyl group (comprising from 3 to 30 carbon atoms), a cycloalkyl group, an arylalkyl group, an alkylaryl group or an acyl group.

The R¹² group is as described above.

Finally, when R¹¹ represents an —SiR¹³R¹⁴R¹⁵ group, the R¹³, R¹⁴ and R¹⁵ groups can be as described above.

According to certain embodiments, at least one of R¹³, R¹⁴ and R¹⁵, preferably at least two of R¹³, R¹⁴ and R¹⁵, and more preferably the three groups R¹³, R¹⁴ and R¹⁵ are alkoxy groups, such as for example a methoxy group, an ethoxy group, a propoxy group or a butoxy group.

According to other embodiments, at least one of R¹³, R¹⁴ and R¹⁵, preferably at least two of R¹³, R¹⁴ and R¹⁵, and more preferably the three groups R¹³, R¹⁴ and R¹⁵ are alkyl groups, such as for example a methyl group, an ethyl group, an isopropyl group, an n-butyl group, an isobutyl group, a sec-butyl group or a tert-butyl group.

According to preferred embodiments, the alkene compounds of formula [Chem 1] may include: octene, decene, vinylcyclohexane, vinylbenzene, vinyltoluene, vinylsilanes, vinylalkoxysilanes such as vinyltrimethoxysilane and vinyltriethoxysilane, 1-(vinyloxy)propane, 1-(vinyloxy)dodecane, 1-(vinyloxy)octadecane, (vinyloxy)cyclohexane, 1-(vinyloxy)butane, 1-(vinyloxy)isobutane, tert-butyl vinyl ether, phenyl vinyl ether, phenyl vinyl sulfide and vinyl methacrylate.

According to certain embodiments, the alkene compound may be of general formula [Chem 2]:

H₂C═CH—CH₂—R¹¹

R¹¹ is as described above.

According to preferred embodiments, the alkene compounds of formula [Chem 2] may include: allyl phenyl ether, allyl phenyl thioether, allyl methacrylate, allyl glycidyl ether, methyl 2-((allyloxy)methyl)acrylate, and allyl trimethylsilane.

According to certain embodiments, the alkene compound may be of general formula [Chem 3]:

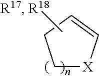

In this formula [Chem 3], X is an oxygen atom, a sulfur atom or a bridge-forming —CH₂— divalent radical.

Moreover, n is an integer from 2 to 10. Preferably, n is from 2 to 8.

According to certain embodiments, the alkene compound of formula [Chem 3] comprises not only one but several double bonds in its ring, for example two or three double bonds.

According to certain embodiments, n is 2 and X is a bridge-forming —CH₂-divalent radical. In this case, the alkene compound of formula [Chem 3] has the structure of norbornene.

The R¹⁷ and R¹⁸ groups represent, independently of one another, a hydrogen atom, a linear or branched alkyl group comprising from 1 to 10 carbon atoms, a linear or branched alkene group comprising from 1 to 10 carbon atoms or a —CH₂— divalent radical forming a bridge with the ring.

According to certain embodiments, at least one of R¹⁷ and R¹⁸ represents a linear alkyl group having from 2 to 8 carbon atoms.

According to certain embodiments, at least one of R¹⁷ and R¹⁸ represents a linear alkene group having from 1 to 5 carbon atoms.

According to certain embodiments, at least one of R¹⁷ and R¹⁸ represents a hydrogen atom. Alternatively, both of R¹⁷ and R¹⁸ represent a hydrogen atom.

Preferred alkene compounds of formula [Chem 3] may be 2,3-dihydrofuran, 3,4-dihydro-2H-pyran, 2,3,4,5-tetrahydrooxepine, or 3,4,5,6-tetrahydro-2H-oxocine.

According to preferred embodiments, the alkene compound may be chosen from octene, decene, allyltrimethylsilane, vinyltrimethoxysilane and vinyltriethoxysilane.

According to certain embodiments, part A of the composition comprises a single alkene compound.

Alternatively, part A of the composition may comprise more than one alkene compound, for example two or three or four or five alkene compounds.

The alkene compound is present in part A of the composition at a weight content of 50% to 95%, and preferably of 55% to 92%, relative to the total weight of part A of the composition. Thus, the alkene compound may in particular have a weight content of 50% to 55%; or of 55% to 60%; or of 60% to 65%; or of 65% to 70%; or of 70% to 75%; or of 75% to 80%; or of 80% to 85%; or of 85% to 90%; or of 90% to 95% relative to the total weight of part A of the composition.

Preferably, the alkene compound has a boiling point at 101 325 Pa (1 atm) above or equal to 50° C., preferably above or equal to 80° C., and preferably above or equal to 100° C. For example, the alkene compound may have a boiling point of from 50° C. to 55° C.; or from 55° C. to 60° C.; 60° C. to 65° C.; or from 65° C. to 70° C.; or from 70° C. to 75° C.; or from 75° C. to 80° C.; or from 80° C. to 85° C.; or from 85° C. to 90° C.; or from 90° C. to 95° C.; or from 95° C. to 100° C.; or from 100° C. to 105° C.; or from 105° C. to 110° C.; or from 110° C. to 115° C.; or from 115° C. to 120° C.; or above 120° C.

It is moreover preferable for the alkene compound to be liquid in a temperature range of from 20° C. to 30° C., and preferably from 23° C. to 25° C.

Radically Polymerizable Compound

The two-component composition comprises at least one radically polymerizable compound comprising at least one ethylenic bond. “Radical polymerization” is a chain polymerization which involves radicals as active species. It involves initiation, propagation, termination and chain transfer reactions. Thus, after in situ formation of the organoborane in part A, the organoborane can initiate the polymerization of the polymerizable compound(s) of part B to form a network of polymer(s).

This compound is only present in part B of the composition.

In the context of the invention, the radically polymerizable compound is chosen from acrylic monomers, methacrylic compounds, and combinations thereof. These may include acrylic and methacrylic monomers or oligomers such as acrylic acid, methacrylic acid, acrylonitrile, methacrylonitrile, acrylic acid amides (or acrylamides), methacrylic acid amides (or methacrylamides), acrylic acid esters (or acrylates) and methacrylic acid esters (or methacrylates).

According to preferred embodiments, the radically polymerizable compound is an acrylic or methacrylic monomer such as acrylic acid, methacrylic acid, acrylonitrile, methacrylonitrile, acrylamides, methacrylamides, acrylates and methacrylates.

The radically polymerizable compound may for example be chosen from acrylic acid, methacrylic acid, acrylate monomers, methacrylate monomers, and mixtures thereof, the alkyl group of the acrylic esters (acrylates) and methacrylic esters (methacrylates) preferably comprising from 1 to 22 carbon atoms, being saturated or unsaturated, linear, branched or cyclic, and possibly including at least one heteroatom (0, S) or one ester function (—COO—); and the alkyl group preferably comprising from 1 to 12 carbon atoms and being linear, branched or cyclic.

Advantageously, the radically polymerizable compound may be chosen from alkyl and cycloalkyl acrylates and methacrylates such as acrylic acid, methyl acrylate, ethyl acrylate, n-propyl acrylate, isopropyl acrylate, allyl acrylate, n-butyl acrylate, isobutyl acrylate, t-butyl acrylate, n-hexyl acrylate, n-octyl acrylate, isooctyl acrylate (SR440 sold by Sartomer), 2-ethylhexyl acrylate, n-decyl acrylate, isodecyl acrylate (SR395 sold by Sartomer), lauryl acrylate (SR335 sold by Sartomer), tridecyl acrylate (SR489 sold by Sartomer), C12-C14 alkyl acrylate (SR336 sold by Sartomer), n-octadecyl acrylate (SR484 sold by Sartomer), C16-C18 alkyl acrylate (SR257C sold by Sartomer), cyclohexyl acrylate, t-butylcyclohexyl acrylate (SR217 sold by Sartomer), 3,3,5-trimethylcyclohexyl acrylate (SR420 sold by Sartomer), isobornyl acrylate (SR506D sold by Sartomer), methacrylic acid, methyl methacrylate, ethyl methacrylate, n-propyl methacrylate, allyl methacrylate, isopropyl methacrylate, n-butyl methacrylate, isobutyl methacrylate, t-butyl methacrylate, cyclohexyl methacrylate, n-hexyl methacrylate, n-octyl methacrylate, isooctyl methacrylate, 2-ethylhexyl methacrylate, isobornyl methacrylate, n-decyl methacrylate, isodecyl methacrylate, n-dodecyl methacrylate, tridecyl methacrylate, and mixtures thereof. Particularly preferred compounds are methyl acrylate, ethyl acrylate, butyl acrylate, 2-ethylhexyl acrylate, methyl methacrylate, ethyl methacrylate, butyl methacrylate and 2-ethylhexyl methacrylate.

In addition, the radically polymerizable compound may be chosen from acrylates and methacrylates comprising heteroatoms, that is to say acrylates and methacrylates which contain at least one atom which is not a carbon or hydrogen in the group of the alcohol part of the ester (without taking into account the atoms of the ester group itself). Preferably, the atom is an oxygen. Thus, the radically polymerizable compound may be chosen from tetrahydrofurfuryl acrylate (SR285 sold by Sartomer), tetrahydrofurfuryl methacrylate (SR203H sold by Sartomer), glycidyl acrylate, 2-hydroxyethyl acrylate, 2- and 3-hydroxypropyl acrylate, 2-methoxyethyl acrylate, 2-ethoxyethyl acrylate, 2- and 3-ethoxypropyl acrylate, 2-(2-ethoxyethoxy)ethyl acrylate (SR256 sold by Sartomer), methoxypolyethylene glycol acrylate (preferably comprising 2 to 8 (ethoxy) repeating units), polyethylene glycol acrylate (preferably comprising 2 to 8 (ethoxy) repeating units), polypropylene glycol acrylate (preferably comprising 2 to 8 (propoxy) repeating units), polycaprolactone acrylate (SR495B sold by Sartomer), 2-phenoxyethyl acrylate (SR339C sold by Sartomer), 2-[2-[2-(2-phenoxyethoxy)ethoxy]ethoxy]ethyl acrylate (SR410 sold by Sartomer), 2-[2-[2-(2-nonylphenoxyethoxy)ethoxy]ethoxy]ethyl acrylate (SR504D sold by Sartomer), cyclic trimethylolpropane formal acrylate (SR531 sold by Sartomer), cyclic glycerol formal acrylate, 2-[2-[2-(2-dodecyloxyethoxy)ethoxy]ethoxy]ethyl acrylate (SR9075 sold by Sartomer), glycidyl methacrylate, 2-hydroxyethyl methacrylate, 2- and 3-hydroxypropyl methacrylate, 2-methoxyethyl methacrylate, 2-ethoxyethyl methacrylate, 2- and 3-ethoxypropyl methacrylate, 2-(2-ethoxyethoxy)ethyl methacrylate, methoxypolyethylene glycol methacrylate (preferably comprising 2 to 8 (ethoxy) repeating units), polyethylene glycol methacrylate (preferably comprising 2 to 8 (ethoxy) repeating units), polypropylene glycol methacrylate (preferably comprising 2 to 8 (propoxy) repeating units), cyclic trimethylolpropane formal methacrylate, cyclic glycerol formal methacrylate (Visiomer® Glyfoma sold by Evonik), and mixtures thereof. Acrylates and methacrylates of ethylene glycol, diethylene glycol, trimethylpropane, triethylene glycol, tetraethylene glycol, dipropylene glycol, tripropylene glycol, tetrapropylene glycol, and pentapropylene may also be used. Particularly preferred compounds are 2-hydroxyethyl acrylate, 2-hydroxypropyl acrylate, polycaprolactone acrylate, 2-hydroxyethyl methacrylate, 2-hydroxypropyl methacrylate and polycaprolactone methacrylate.

Diacrylate and dimethacrylate compounds may also be used within the context of this invention. Such compounds include ethylene glycol diacrylate, 1,3-butylene glycol diacrylate, 1,4-butanediol diacrylate, 1,6-hexanediol diacrylate (SR238 sold by Sartomer), 3-methyl-1,5-pentanediol diacrylate (SR341 sold by Sartomer), cyclohexanedimethanol diacrylate, neopentyl glycol diacrylate, 1,10-decanediol diacrylate (SR595 sold by Sartomer), tricyclodecanedimethanol diacrylate (SR833S sold by Sartomer), esterdiol diacrylate (SR606A sold by Sartomer), alkoxylated aliphatic diacrylates such as diethylene glycol diacrylate, triethylene glycol diacrylate (SR272 sold by Sartomer), dipropylene glycol diacrylate (SR508 sold by Sartomer), tripropylene glycol diacrylate (SR306 sold by Sartomer), tetraethylene glycol diacrylate (SR268G sold by Sartomer), ethoxylated and/or propoxylated cyclohexanedimethanol diacrylates, ethoxylated and/or propoxylated hexanediol diacrylates, ethoxylated and/or propoxylated neopentyl glycol diacrylates, caprolactone-modified neopentyl glycol hydroxypivalate diacrylate, dipropylene glycol diacrylate, ethoxylated (3) bisphenol A diacrylate (SR349 sold by Sartomer), ethoxylated (10) bisphenol A diacrylate (SR602 sold by Sartomer), ethoxylated (30) bisphenol A diacrylate, ethoxylated (40) bisphenol A diacrylate, polyethylene glycol (200) diacrylate (SR259 sold by Sartomer), polyethylene glycol (400) diacrylate (SR344 sold by Sartomer), polyethylene glycol (600) diacrylate (SR610 sold by Sartomer), propoxylated neopentyl glycol diacrylates, ethylene glycol dimethacrylate, 1,3-butylene glycol dimethacrylate, 1,4-butanediol dimethacrylate, 1,6-hexanediol dimethacrylate, 3-methyl-1,5-pentanediol dimethacrylate, 1,6-hexanediol monoacrylate monomethacrylate, cyclohexanedimethanol dimethacrylate, neopentyl glycol dimethacrylate, tricyclodecanedimethanol dimethacrylate, alkoxylated aliphatic methacrylates such as triethylene glycol dimethacrylate, tripropylene glycol dimethacrylate, tetraethylene glycol dimethacrylate, ethoxylated and/or propoxylated cyclohexanedimethanol dimethacrylates, ethoxylated and/or propoxylated hexanediol dimethacrylates, ethoxylated and/or propoxylated neopentyl glycol dimethacrylates, caprolactone-modified neopentyl glycol hydroxypivalate dimethacrylate, diethylene glycol dimethacrylate, dipropylene glycol dimethacrylate, tripropylene glycol dimethacrylate, ethoxylated (10) bisphenol A dimethacrylate, ethoxylated (3) bisphenol A dimethacrylate, ethoxylated (30) bisphenol A dimethacrylate, ethoxylated (40) bisphenol A dimethacrylate, polyethylene glycol (200) dimethacrylate, polyethylene glycol (400) dimethacrylate, polyethylene glycol (600) dimethacrylate, ethoxylated and/or propoxylated neopentyl glycol dimethacrylates, and mixtures thereof. Triacrylate and trimethacrylate compounds may also be used within the context of this invention. Such compounds include glyceryol trimethacrylate, glycerol triacrylate, ethoxylated and/or propoxylated glycerol triacrylates, trimethylolpropane triacrylate (SR351 sold by Sartomer), ethoxylated and/or propoxylated trimethylolpropane triacrylates, pentaerythritol triacrylate (SR444D sold by Sartomer), ethoxylated and/or propoxylated trimethylolpropane triacrylates, trimethylolpropane trimethacrylate, and tris(2-hydroxyethyl)isocyanurate triacrylate (SR368 sold by Sartomer), tris(2-hydroxyethyl)isocyanurate trimethacrylate, ethoxylated and/or propoxylated glycerol trimethacrylates, ethoxylated and/or propoxylated trimethylolpropane trimethacrylates, and pentaerythritol trimethacrylate.

Compounds comprising more than three acrylate or methacrylate groups may also be used such as, for example, pentaerythritol tetraacrylate (SR295 sold by Sartomer), ditrimethylolpropane tetraacrylate (SR355 sold by Sartomer), dipentaerythritol pentaacrylate (SR399 sold by Sartomer), ethoxylated and/or propoxylated pentaerythritol tetraacrylates, pentaerythritol tetramethacrylate, ditrimethylolpropane tetramethacrylate, dipentaerythritol pentamethacrylate and ethoxylated and/or propoxylated pentaerythritol tetramethacrylates.

In addition, the radically polymerizable compound may be chosen from acrylic and methacrylic oligomers such as urethane-acrylates and urethane-methacrylates, polyester-acrylates, polyester-methacrylates, polybutadiene-acrylates (SR307 sold by Sartomer) and polybutadiene-methacrylates.

Preferred compounds in this category are for example CN1963, CN1964, CN992, CN981, CN9001, CN9002, CN9012, CN9200, CN964A85, CN965, CN966H90, CN991, CN9245S, CN998B80, CN9210, CN9276, CN9209, PRO21596, CN9014NS, CN9800, CN9400, CN9167, CN9170A86, CN9761 and CN9165A, sold by Sartomer.

Radically polymerizable compounds which may be used within the context of the invention may also include acrylamides and methacrylamides. For example, these monomers may be chosen from acrylamide, methacrylamide, N-(hydroxymethyl)acrylamide, N-(hydroxyethyl)acrylamide, N-(isobutoxymethyl)acrylamide, N-(3-methoxypropyl)acrylamide, N-[tris(hydroxymethyl)methyl]acrylamide, N-isopropylacrylamide, N-[3-(dimethylamino)propyl]methacrylamide, diacetone acrylamide, N,N′-methylenedimethacrylamide, N,N′-methylenediacrylamide, N,N′-(1,2-dihydroxyethylene)bismethacrylamide and N,N′-(1,2-dihydroxyethylene)bisacrylamide and also from the acrylamides and methacrylamides formed after reaction of acrylic or methacrylic acid (or of the acyl chloride of this acid) with primary and/or secondary (poly)amines such as 1,3-diaminopropane, N,N′-dimethyl-1,3-diaminopropane, 1,4-diaminobutane, polyamidoamines and polyoxyalkylenepolyamines. According to certain embodiments, a single radically polymerizable compound (as defined above) is present in part B of the composition. According to other embodiments, several compounds radically polymerizable compounds (as defined above) are present in part B of the composition.

The radically polymerizable compound(s) may be present in part B of the composition at a weight content of 10% to 99%, and preferably of 30% to 95%, relative to the total weight of part B the composition. This content may for example be from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 99%.

Part B is devoid of alkene compounds, as defined opposite.

Two-Component Composition

The two-component composition may also comprise at least one additional amine, the additional amine being as defined above.

Preferably, the additional amine is present in part A of the composition. The presence of the amine (in excess relative to the borane) makes it possible to stabilize part A of the composition), so as to increase its storage life.

According to certain embodiments, this additional amine is the same as the amine present in the borane-amine complex.

According to other embodiments, this additional amine is different from the amine present in the borane-amine complex.

According to certain embodiments, a single additional amine is present in the two-component composition.

According to other embodiments, two or more than two additional amines are present in the two-component composition.

According to preferred embodiments, it is a polyetheramine.

The additional amine may be present in the two-component composition, and preferably in part A of the composition, at a weight content of 0.01% to 30%, and preferably of 0.01% to 25%, relative to the total weight of the composition and preferably relative to the total weight of part A of the composition. This content may be in particular from 0.01% to 0.5%; or from 0.5% to 1%; or from 1% to 5%; or from 5% to 10%; or from 10% to 15%; or from 15% to 20%; or from 20% to 25%; or from 25% to 30%.

The two-component composition may also comprise one or more additives chosen from fillers, plasticizers, tackifying resins, solvents, UV stabilizers, moisture absorbers, fluorescent materials and rheological additives.

Such additives may be present in one of the two parts of the composition, or alternatively in both parts of the composition.

For example, part A of the two-component composition may comprise fillers, plasticizers, tackifying resins, solvents, UV stabilizers, moisture absorbers, fluorescent materials and rheological additives.

Part B of the two-component composition may for example comprise fillers and plasticizers.

The fillers may be chosen from talc, mica, kaolin, bentonite, aluminum oxides, titanium oxides, iron oxides, barium sulfate, hornblende, amphiboles, chrysotile, carbon black, carbon fibers, fumed or pyrogenic silicas, molecular sieves, calcium carbonate, wollastonite, glass beads, glass fibers, and combinations thereof.

As regards the plasticizer, this may be chosen from those known to a person skilled in the art in the coating or adhesive industries. Mention may be made, for example, of plasticizers based on phthalate, polyol ester (such as, for example, pentaerythritol tetravalerate, sold by Perstorp), epoxidized oil, alkylsulfonic esters of phenol (the Mesamoll® product sold by Lanxess), and mixtures thereof.

The tackifying resin may in particular be chosen from: resins obtained by polymerization of terpene hydrocarbons and of phenols, in the presence of Friedel-Crafts catalysts, such as the Dertophene® 1510 resin available from DRT having a molar mass of approximately 870 Da, Dertophene® H150 available from the same company with a molar mass equal to approximately 630 Da, Sylvarez® TP 95 available from Arizona Chemical having a molar mass of approximately 1200 Da; resins obtained by a process comprising the polymerization of α-methylstyrene such as the Norsolene® W100 resin available from Cray Valley, which is obtained by polymerization of α-methylstyrene without the action of phenols, with a number-average molar mass of 900 Da, Sylvarez® 510 which is also available from Arizona Chemical with a molar mass of approximately 1740 Da, the process for the production of which also comprises the addition of phenols; natural-origin or modified rosins, and derivatives thereof which are hydrogenated, dimerized, polymerized or esterified with monoalcohols or polyols such as the Sylvalite® RE 100 resin which is an ester of rosin and of pentaerythritol available from Arizona Chemical and has a molar mass of approximately 1700 Da; resins obtained by hydrogenation, polymerization or copolymerization of mixtures of unsaturated aliphatic hydrocarbons having approximately 5, 9 or 10 carbon atoms obtained from petroleum fractions; terpene resins; copolymers based on natural terpenes; and acrylic resins having a viscosity at 100° C. of less than 100 Pa·s.

The solvent may be a solvent which is volatile at ambient temperature (temperature of the order of 23° C.). The volatile solvent may, for example, be chosen from alcohols which are volatile at ambient temperature, such as ethanol or isopropanol. The volatile solvent makes it possible, for example, to reduce the viscosity of the two-component composition (of part A and/or of part B) and make the composition easier to apply. The volatile character of the solvent makes it possible for the product, obtained after crosslinking the composition, to no longer contain solvent.

The UV stabilizers may be chosen from benzotriazoles, benzophenones, “hindered” amines, such as bis(2,2,6,6-tetramethyl-4-piperidyl) sebacate, and mixtures thereof. Mention may be made, for example, of the products Tinuvin® 328 or Tinuvin™ 770, sold by BASF.

The fluorescent material may for example be 2,5-thiophenediylbis(5-tert-butyl-1,3-benzoxazole) (Uvitex® OB).

As regards the rheological additives, these may be chosen from those known to a person skilled in the art in the coating or adhesive industries. Mention may be made, for example, of silica (in particular pyrogenic silica), or a micronized amide wax (such as, for example, the Crayvallac series sold by Arkema).

The additives may be present in the two-component composition at a weight content of 0.01% to 70%, preferably of 0.01% to 50%, preferably of 0.01% to 30%, more preferably of 0.01% to 10%, relative to the total weight of the composition.

Thus, the additives may in particular be present in the two-component composition at a weight content of 0.01% to 0.05%; or of 0.05% to 0.1%; or of 0.1% to 0.5%; or of 0.5% to 1%; or of 1% to 5%; or of 5% to 10%; or of 10% to 20%; or of 20% to 30%; or of 30% to 40%; or of 40% to 50%; or of 50% to 60%; or of 60% to 70%.

According to preferred embodiments, the two-component composition according to the invention is devoid of decomplexing agents for decomplexing the borane and the amine. The term “decomplexing agent” is understood to mean a compound capable of reacting with the amine present in the borane-amine complex in order to release the borane. For example, the decomplexing agent may an isocyanate, a Lewis acid, a carboxylic acid, a mineral acid, a phosphonic acid, a sulfonic acid, an acyl chloride, an anhydride, an aldehyde, a 1,3-dicarbonyl compound, and an epoxide. Preferably, the two-component composition according to the invention is devoid of isocyanate compound.

Parts A and B of the two-component composition may preferably remain separate until the composition is used. Thus, the initiation of the polymerization commences when part A of the composition comes into contact with part B.

The volume ratio of part A of the composition to part B may be from 1:1 to 1:40, and preferentially from 1:1 to 1:10. According to certain preferred embodiments, this ratio may be approximately 1. For example, this ratio may be from 1:1 to 1:5; or from 1:5 to 1:10; or from 1:10 to 1:15; or from 1:15 to 1:20; or from 1:20 to 1:25; or from 1:25 to 1:30; or from 1:30 to 1:35; or from 1:35 to 1:40.

Use of the Composition

The two-component composition according to the invention can be used for the treatment of substrates having a low surface energy. More particularly, the two-component composition according to the invention can be used for the treatment of substrates having a surface energy of less than or equal to 45 mJ/m², preferably of less than or equal to 40 mJ/m², and more preferably of less than or equal to 35 mJ/m². For example, this surface energy may be from 10 to 15 mJ/m²; or from 15 to 20 mJ/m²; or 20 to 25 mJ/m²; or from 25 to 30 mJ/m²; or 30 to 35 mJ/m²; or from 35 to 40 mJ/m²; or from 40 to 45 mJ/m². Substrates exhibiting a low surface energy are, for example, polyolefins such as polyethylene, polypropylene, polybutadiene, polyisoprene, poly(vinylidene fluoride), polytetrafluoroethylene, and also the copolymers thereof. These surface energy values are well known in the prior art.

According to certain embodiments, part A of the composition can be mixed with part B, before coating of the two-component composition (mixture of parts A and B) on the surface of a substrate. Thus, the initiation of polymerization commences when the two parts are mixed.

According to other embodiments, one of the two parts A and B of the composition can be coated on the surface of the substrate in a first stage, and in a second stage the second of the two parts can be coated on the surface of the substrate on top of the first of the two parts. Thus, the initiation of the polymerization commences when the second of parts A and B of the composition is coated on the surface of the substrate.

According to certain embodiments, the polymerizable composition may be coated onto the surface of the substrate at a temperature of 20 to 100° C., and preferably of 35 to 85° C.

According to certain embodiments, in a first stage part A is coated on the surface of the substrate, and then in a second stage part B is coated on top of part A on the surface of the substrate.

According to other embodiments, in a first stage part A is coated on the surface of the substrate, and then in a second stage part B is coated on top of part A on the surface of the substrate.

Thus, in both embodiments, the two-component composition can form a layer on the surface of the substrate. This layer may have a thickness of 1 μm to 500 mm, and preferably 10 μm to 100 mm, and more preferably 10 μm to 10 mm.

According to certain embodiments, the two-component composition according to the invention can be used as an adhesive composition, so as to bond two substrates together. Thus, after crosslinking, the composition can form an adhesive layer holding two substrates fixed together. More particularly, after coating the two-component composition on the surface of a substrate, the surface of an additional substrate can be brought into contact with the coated surface, so as to bond the two substrates. According to certain embodiments, bringing the additional substrate into contact with the coated surface, the assembly can be placed under a heating press so as to accelerate the bonding of the two substrates together. The temperature of this press can be for example from 50 to 140° C., and preferably from 50 to 120° C.

Preferably, at least one of the two substrates is a substrate having a low surface energy. The second substrate can also be a substrate having a low surface energy. Alternatively, the second substrate may be a material chosen from paper, a metal such as aluminum, a polymeric material other than low surface energy substrates, such as polyamides, polystyrene, vinyl polymers such as polyvinyl chloride, polyethers, polyurethanes, polyesters, acrylonitrile-butadiene-styrene, poly(methyl methacrylate), and natural or synthetic rubber.

According to other embodiments, the two-component composition according to the invention can be used as a coating on the surface of a substrate. Thus, after crosslinking, the composition can form a layer covering the surface of the substrate in order for example to modify one or more properties of its surface. Preferably, this substrate has a low surface energy, as described above.

According to yet other embodiments, the two-component composition according to the invention can be used as a primer. The term “primer” is understood to mean a layer coated on a substrate so as to improve one or more surface properties of this substrate (for example so as to improve the adhesion of the substrate to a material), so that additional layers can be applied to the substrate comprising the primer layer. For example, the coating of the two-component composition according to the invention on a low surface energy substrate can make it possible to increase the surface energy thereof in order to facilitate the application of another adhesive composition on top of the two-component composition.

Thus, the articles manufactured after application of the composition according to the invention comprise at least one surface coated with the two-component composition.

When the two-component composition is used as a primer or coating, this is an external surface of the article.

When the two-component composition is used as an adhesive, this is an internal surface of the article, that is to say a surface of the article which is in contact with, for example, another surface of the article, with the two-component composition being located between these two surfaces.

The crosslinked two-component composition may exhibit an elongation at break of greater than or equal to 30%. This elongation at break may be, for example, from 30% to 40%; or from 40% to 50%; or from 50% to 60%; or from 60% to 70%; or from 70% to 80%; or from 80% to 90%; or from 90% to 100%; or greater than 100%. The elongation at break can be measured according to the standard ISO 37.

The crosslinked two-component composition may exhibit a modulus of elasticity of less than or equal to 100 MPa and more preferably of less than or equal to 60 MPa; it may, for example, be from 1 to 100 MPa, preferably from 3 to 50 MPa. The modulus of elasticity can be measured according to the standard ISO 37.

### Example

The following example illustrates the invention without limiting it.

Six two-component compositions (A to F) were prepared by mixing a part A with a part B.

Parts A and B were prepared in an amount of 100 g each and at a ratio of 1:10 (A:B).

Part A of compositions A to C comprises a borane-amine complex and an alkene compound as indicated in the table below. Part A of the composition D is devoid of alkene compounds. Part A of compositions E and F comprises 25% and 100% respectively of a triethylborane-amine complex (comparative examples). Part A of composition E comprises a plasticizer (Mesamoll® sold by the company LANXESS, phenyl alkylsulfonic ester) whereas part A of composition F is devoid of decomplexing agent.

TABLE 1

| Comp. | Borane-amine complex | Alkene |
|---|---|---|
| A | 25.4% of N-ethyl diisopropylamine-borane | 74.6% decene |
| B | 20.3% of N-ethyl diisopropylamine-borane | 79.7% decene |
| C | 9.3% of N-ethyl diisopropylamine-borane | 90.7% decene |
| D | 100% of N-ethyl diisopropylamine-borane | — |
| E | 25% of diaminopropanamine-triethylborane | — |
| | in 75% of Mesamoll ® | |
| F | 100% of diaminopropanamine-triethylborane | — |

Part B of compositions A to D and F is identical and comprises 91% of methyl methacrylate monomer, 8% of a fumed silica (AEROSIL® R202 sold by the company EVONIK) and 1% of glass beads (SiO₂). Part B of composition E comprises 89.8% of methyl methacrylate monomer, 1.2% of succinic anhydride as decomplexing agent, 8% of a fumed silica (AEROSIL® R202 sold by the company EVONIK) and 1% of glass beads (SiO₂).

In this example, each composition (A to F) was coated on a surface (25 mm×10 mm) of a polypropylene substrate having dimensions of 100 mm×25 mm×5 mm. A second substrate of the same type is then brought into contact with the substrate comprising the two-component composition so as to bond the two substrates together. The two substrates are held against one another with clamps for 24 days. The shear strength of the manufactured articles is then tested using a universal testing machine at a rate of 10 mm/min. The values obtained correspond to an average of 3 measurements. The shear strength is reported with the failure mode.

The results are shown in the table below.

TABLE 2

| Compositions | Shear strength (MPa) | Failure mode |
|---|---|---|
| A | 4.9 | CF |
| B | 3.5 | CF |
| C | 3.9 | CF |
| D | 0 | — |
| E | 4.7 | CF |
| F | 0 | — |

CF = cohesive failure

It is observed that the articles manufactured from compositions A to C have good adhesive properties comparable to those obtained in the case of composition E comprising a diaminopropanamine-triethylborane complex with a decomplexing agent.

1-12. (canceled)

13. A two-component composition comprising:
a first part (A) comprising a borane BH₃-amine complex and an alkene compound, said alkene compound being selected from the group consisting of:
1) an alkene compound of general formula [Chem 1]
H₂C═CH—R¹¹
R¹¹ representing a group comprising from 3 to 31 carbon atoms selected from the group consisting of a linear or branched alkyl group, an aryl group, an arylalkyl group, a cycloalkyl group, an —OR¹² group, an —SR¹² group and an —SiR¹³R¹⁴R¹⁵ group;
R¹² being selected from the group consisting of a linear or branched alkyl group, an alkylaryl group, a cycloalkyl group, an acyl group;
R¹³, R¹⁴, R¹⁵ being selected from the group consisting of, independently of one another, a linear or branched alkyl group, an aryl group, a cycloalkyl group or an alkoxy group;
2) an alkene compound of general formula [Chem 2]
H₂C═CH—CH₂—R¹¹
R¹¹ representing a group comprising from 3 to 31 carbon atoms selected from the group consisting of a linear or branched alkyl group, an aryl group, an alkylaryl group, a cycloalkyl group, an —OR¹² group, an —SR¹² group and an —SiR¹³R¹⁴R¹⁵ group;
R¹² being selected from the group consisting of a linear or branched alkyl group, an arylalkyl group, a cycloalkyl group or an acyl group;
R¹³, R¹⁴, R¹⁵ being selected from the group consisting of, independently of one another, a linear or branched alkyl group, an aryl group, a cycloalkyl group or an alkoxy group;
and/or
3) an alkene compound of general formula [Chem 3] 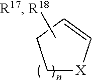
X being an oxygen atom, a sulfur atom or a bridge-forming —CH₂— divalent radical;
n being an integer from 2 to 10; and
R¹⁷ and R¹⁸ representing, independently of one another, a hydrogen atom, a linear or branched alkyl group comprising from 1 to 10 carbon atoms, a linear or branched alkene group comprising from 1 to 10 carbon atoms or a —CH₂— divalent radical forming a bridge with the ring; and
a second part (B) comprising at least one radically polymerizable compound comprising at least one ethylenic bond chosen from an acrylic monomer, a methacrylic monomer or a combination thereof.

14. The two-component composition as claimed in claim 13, wherein the amine is selected from the group consisting of diisopropylamine, N-methyldiisopropylamine, N-ethyldiisopropylamine, dicyclohexylamine, N-methyldicyclohexylamine, N-ethyldicyclohexylamine, di-sec-butylamine, di-tert-butylamine, 1,1,1,3,3,3-hexamethyldisilazane, N-methyl-1,1,1,3,3,3-hexamethyldisilazane, N-ethyl-1,1,1,3,3,3-hexamethyldisilazane, 2,6-dimethylpiperidine, N-methyl-2,6-dimethylpiperidine, N-ethyl-2,6-dimethylpiperidine, 7-azabicyclo[2.2.1]heptane, N-ethyl-7-azabicyclo[2.2.1]heptane, 1-azabicyclo[2.2.2]octane and combinations thereof.

15. The two-component composition as claimed in claim 13, wherein the radically polymerizable compound is selected from the group consisting of an acrylate, an acrylic acid, an acrylamide, an acrylonitrile, a methacrylate, a methacrylic acid, a methacrylamide, a methacrylonitrile and combinations thereof.

16. The two-component composition as claimed in claim 13, wherein the alkene compound is selected from the group consisting of decene, octene, allyltrimethylsilane, vinyltrimethoxysilane, vinyltriethoxysilane and combinations thereof.

17. The two-component composition as claimed in claim 13, wherein the borane BH₃-amine complex and the alkene compound are present in part (A) of the composition in a molar ratio of 1:1 to 1:20.

18. The composition as claimed in claim 13, wherein the radically polymerizable compound has a weight content of 10% to 99% in part B of the composition.

19. The composition as claimed in claim 13, wherein the volume ratio of part (A) to part (B) is from 1:1 to 1:40.

20. The two-component composition as claimed in claim 13, wherein said composition is devoid of decomplexing agents for decomplexing the borane and the amine.

21. An adhesive composition obtained by mixing parts (A) and (B) of the two-component composition as claimed in claim 13.

22. A method for binding two substrates together comprising applying the two-component composition of claim 13.

23. The method of claim 22, wherein at least one of the two substrates has a surface energy of less than or equal to 45 mJ/m².

24. An article comprising at least one layer obtained by crosslinking the composition as claimed in claim 13.
